(19) United States
(12) Patent Application Publication
(10) Pub. No.: US 2003/0123408 A1
(43) Pub. Date: Jul. 3, 2003

(54) CDMA receiving apparatus

(76) Inventor: Naoyuki Saitou, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/117,600

(22) Filed: Apr. 5, 2002

(30) Foreign Application Priority Data
Dec. 28, 2001 (JP) JP2001-398978

(51) Int. Cl. H04B 7/216

(52) U.S. Cl. 370/335; 370/342; 375/130; 375/150

(57) ABSTRACT

A CDMA receiving apparatus has an AD conversion unit (54, 55) for converting a receive signal to digital data and outputting digital data obtained by 2×oversampling; a correlation calculation unit (56b) for calculating correlation between a reference code sequence, which is a code sequence identical with a spreading code sequence, and the digital data sequence; an interpolator (56d) for performing interpolation between correlation values to thereby generate a correlation-value data sequence corresponding to 4×oversampling; and a timing decision unit (56f) for obtaining a peak timing of correlation values as a delay time of a signal that arrives via a prescribed path, and deciding despread-start timing based upon this delay time.

### BACKGROUND OF THE INVENTION

This invention relates to a CDMA receiving apparatus in a CDMA communications system for receiving a signal that is the result of spreading transmit data by a spreading code sequence of a predetermined chip frequency, and demodulating the transmit data by applying despread processing to the receive signal using a code sequence identical with the spreading code sequence. More particularly, the invention relates to a CDMA receiving apparatus for deciding delay time on each path of multiple paths.

In mobile communications, maximum frequency is decided by the velocity of the mobile station and the frequency of the carrier waves. Random changes in amplitude and phase therefore occur and so does fading. As a consequence, it is very difficult to achieve stable reception in comparison with stationary radio communications. A spread-spectrum communication scheme is effective as means for mitigating such deterioration caused by the influence of frequency-selective fading. The reason for this is that since a narrow-band signal is spread over a high-frequency band and then transmitted, information from other bands can be reconstructed without error even if a decline in reception field strength occurs in a certain frequency band. Accordingly, DC-CDMA (Direct Sequence Code Division Multiple Access) technology is being adopted in mobile communications between a mobile terminal or station (MS) and a base station (BTS) in 3^{rd} Generation W-CDMA schemes.

Further, with mobile communications, delayed waves from high-rise buildings or mountains give rise to fading, which results in a multipath fading environment. In the case of direct sequence (DS), the delayed waves constitute interference with respect to the spreading code and invite a decline in reception characteristics. RAKE reception is known as one method in which such delayed waves are used positively in improvement of characteristics. RAKE reception involves subjecting each delayed wave that arrives via each path of multipath to despreading, making the delay times agree, subsequently performing synchronous detection, and adding the signals upon applying weighting in accordance with the reception level, thereby combining the signals.

FIG. 11 is a block diagram of a CDMA transmitter in a mobile station. An error-correction encoder 1 subjects a transmit signal to error correction processing and inputs the processed signal to a mapper 2a in the CDMA transmitter. The latter further includes a control data generator 2b for generating control data such as a pilot PILOT and transmission power control data TPC and inputting the generated data to the mapper 2a. The mapper 2a, to which the transmit data subjected to error correction processing has been applied, outputs this transmit data at a predetermined symbol rate as in-phase component data in quadrature modulation, and outputs the control data at a fixed symbol speed as quadrature component data. Spreaders 2c, 2d subject the in-phase component (Ich component) and quadrature component (Qch component), respectively, which enter from the mapper 2a, to spreading modulation using a spreading code sequence of a predetermined chip frequency, and input the resulting spread data sequences to DA converters 2g, 2h, respectively, via waveshaping filters 2e, 2f, respectively. A quadrature modulating circuit 2i applies QPSK quadrature modulation to Ich and Qch signals output from the DA converters 2g, 2h, respectively, and a radio unit 2j converts a baseband signal, which is output from the quadrature modulating circuit 2i, to a high-frequency signal by a frequency conversion (IF→RF conversion) and transmits this signal from an antenna upon subjecting the signal to high-frequency amplification, etc.

FIG. 12 is a block diagram of one channel of a CDMA receiving section in a CDMA receiver of a base station. A radio unit 3 converts a high-frequency signal, which has been received by an antenna, to a baseband signal by a frequency conversion (RF→IF conversion). A quadrature detector 4 subjects the baseband signal to quadrature detection and outputs in-phase component (Ich component) data and quadrature component (Qch component) data. A low-pass filter (LPF) 5 limits the band of the output signal and an AD converter 6 converts the Ich-component signal and Qch-component signal to digital data sequences by sampling them at a predetermined sampling speed, e.g., the chip frequency, and inputs the digital data sequences to a searcher 7 and to each of fingers 8₁ to 8₃.

The searcher 7 has a terminal-acquisition code generator 7a for generating a spreading code, which conforms to the channel assigned to the user terminal, as a terminal acquisition code (reference code); a correlation calculation unit 7b for performing a correlation operation between a receive data sequence output from the AD converter 6 and the reference code sequence; a correlation amplitude adder 7c for adding the results (amplitudes) of the correlation operation and outputting a correlation value of a predetermined timing; a power calculation unit 7d for calculating the absolute value or power of the correlation value; and a timing decision unit 7e for deciding despread-start timing (phase) of each path.

Let In (n=1, 2, . . . ) represent the reference code sequence of the Ich component, a(tn) (n=1, 2, . . . ) the digital data sequence of the Ich component output from the AD converter 6, Qn (n=1, 2, . . . ) the reference code sequence of the Qch component, and b(tn) (n=1, 2, . . . ) the digital data sequence of the Qch component output from the AD converter 6. The correlation amplitude adder 7c performs the following operation every chip period:

Σₙ{a(tn)·In+jb(tn)·Qn}(n=1, 2, . . . ) (1)

and the power calculation unit 7d calculates the power of the correlation value at the chip period in accordance with the following formula:

Σₙ{[a(tn)·In]²+[b(tn)·Qn]²}(n=1, 2, . . . ) (2)

It should be noted that the correlation calculation unit 7b and correlation amplitude adder 7c can be constructed by a matched filter MF shown in FIG. 13. The matched filter MF has a shift register SFR for successively shifting the digital data sequence, which is output from the AD converter 6, at the chip frequency; a reference-code register RSF for holding the reference code (c₀ to cₙ); multipliers MPO to MPn for multiplying the bits of the digital data sequence of the baseband by the corresponding bits of the reference code sequence; and an adder circuit ADD for adding the outputs of the multipliers and outputting the sum. With the matched filter MF, a correlation value between the digital data sequence and reference code sequence at a prescribed timing can be calculated at the chip period, a correlation value between the digital data sequence and reference code sequence at a time shifted by the phase of a single chip period can be calculated at the next timing which is one chip period later, and thus all correlation values at times successively shifted by one chip period can be calculated over one bit of the transmit data. In accordance with this matched filter MF, the correlation value is large at such time that the phases of the digital data sequence and reference code sequence agree.

Thus, if a direct-sequence signal (DS signal) influenced by multipath is input to the searcher 7, large correlation values will be obtained at timings t₁, t₂, t₃ conforming to the delay times (phase lags) of the paths, as shown in FIG. 14, and the power calculation unit 7d will generate a correlation signal having peak values conforming to the reception signal strengths of the respective paths at the above-mentioned timings t₁, t₂, t₃.

When the correlation signal shown in FIG. 14 is input to the timing decision unit 7e, the latter detects multipath and the delay times t₁, t₂, t₃ of the paths based upon signals MP₁, MP₂, MP₃ that are greater than a threshold value, and inputs despread-start timing signals P₁, P₂, P₃ and delay-time adjustment data D₁, D₂, D₃ to respective ones of the fingers 8₁ to 8₃ corresponding to the respective paths.

The fingers 8₁ to 8₃ corresponding to respective ones of the paths are identically constructed and include a despreading code generator 8a for generating a receive-signal demodulation despreading code (a code identical with the spreading code corresponding to the channel assigned to the user terminal); a despreading circuit 8b for multiplying the digital data sequence, which is output from the AD converter 6, by the despreading code to thereby despread the data; an amplitude adder 8c for adding the results (amplitudes) of despreading; and a delay-time adjustment circuit 8d for subjecting the despread signal to a delay-time adjustment corresponding to the path. The despreading circuit 8b applies despread processing to the digital data sequences (I-channel data sequence and Q-channel data sequence) using the despreading codes of its own channel at the timings P₁ to P₃ specified by the searcher 7. The delay-time adjustment circuit 8d delivers the output upon applying a delay equivalent to the times D₁ to D₃ specified by the searcher 7. As a result, the fingers 8₁ to 8₃ perform despreading at a timing identical with that of the spreading code on the transmitting side, adjust delay time in accordance with the paths and input the resulting signals to a maximum-ratio combiner 9 upon matching the phases. The maximum-ratio combiner 9 executes RAKE combining and inputs the combined signals to a data decoder, which is not shown.

The foregoing relates to a case where a digital data sequence, which is obtained by sampling the output signal of the quadrature detector 4 (FIG. 12) at the chip frequency and then applying an analog-to-digital conversion to this signal, is input to the searcher 7. One correlation value is obtained on a per-chip basis. However, with this scheme in which only one correlation value is obtained for each chip, the output of the correlation value diminishes. The reason for this is as follows: If 1 is the correlation-value output prevailing when sampling is performed at a timing at which an eye pattern is open most widely at the time of one chip, the output of the correlation value will decline as the signal departs from this timing. In a scheme in which a single correlation value is calculated on a per-chip basis, the probability of correlation-value calculation at the timing at which the eye pattern is open most widely is low and, hence, the correlation-value output declines. When the correlation-value output becomes small, the precision with which the despread timing is detected declines and good line quality cannot be obtained.

If the sampling frequency is made high, a plurality of correlation values can be obtained over the duration of one chip. With 2×oversampling, two correlation values can be obtained per chip; with 4×oversampling, four correlation values can be obtained per chip; with 8×oversampling, eight correlation values can be obtained per chip. In other words, if the sampling frequency is made n times the chip frequency (if the number of oversamplings is made n), correlation values can be obtained at a phase interval that is 1/n·chip period. Accordingly, a timing at which the correlation values are largest, i.e., the despread timing, can be obtained at a phase precision that is n times greater in comparison with the case where sampling frequency is equal to the chip frequency.

Thus, it is preferred that the AD converter that converts the analog signal received from the antenna to the digital signal execute the analog-to-digital conversion by performing sampling at a frequency that is at least four times the chip frequency. However, because of such factors as heat, scale of the circuitry and interface signal capacity, the state of the art is such that 2×oversampling is performed. The reasons for this will now be described.

Assume that the 360° circumference of a base station is divided into six cells Cell-0 to Cell-5 of 60° each, as shown in FIG. 15, and that each cell is provided with two antennas AT01, AT02 to AT51, AT52 by a diversity arrangement. The structure of the CDMA receiving apparatus in such case would be as illustrated in FIG. 16. Signals received by the antennas AT01, AT02 to AT51, AT52 of the cells Cell-0 to Cell-5 are input to receiver sections RV0 to RV5. Here the signals are subjected to processing for frequency conversion, quadrature demodulation and band limiting, and the processed signals are input to AD converters 6₀₁, 6₀₂ to 6₅₁, 6₅₂ of the corresponding antennas. The AD converters 6₀₁, 6₀₂ to 6₅₁, 6₅₂ subject the analog signals, which are the quadrature-modulated outputs, to nx oversampling, and a multiplexer MUX time-division multiplexes the outputs of the AD converters and sends the multiplexed signal to a transmission line TRL via an LVDS interface. A demultiplexer DMUX receives the multiplexed signal, which is sent from the transmission line TRL, via the LVDS interface, demultiplexes this signal and then inputs the demultiplexed signals to main-signal demodulators DM0 to DM5. The main-signal demodulators DM0 to DM5 have the structure on the right side of FIG. 12 for each channel and demodulate transmit data.

In the structure of FIG. 16, assume that the chip frequency is 3.84 MHz and that oversampling by a factor of four (n=4) is performed by the AD converters. In such case the data transmission speed on transmission line is 4×3.84×12 (MHz) for each of the I and Q channels. This represents a high speed. This makes it necessary to provide a high-speed interface and elements having a high-speed response. There is also an increase in power consumption. In view of these factors (heat, scale of the circuitry and interface signal capacity, etc.), 2×oversampling is performed rather than 4×oversampling.

First Problem

If nx oversampling is performed, as mentioned above, correlation values can be obtained at a phase interval that is 1/n of a chip period, and a timing at which a correlation value is largest, i.e., the despread timing, can be obtained at a phase precision that is n times greater in comparison with the case where sampling frequency is equal to the chip frequency. With 2×oversampling, therefore, detection precision of despread timing falls to one-fourth or one-half in comparison with 8×oversampling or 4×oversampling. Moreover, over the duration of one chip, the correlation-value output diminishes as the signal departs from the timing at which an eye pattern is open most widely. In a case where the peak timing occurs in the middle of 2×oversampling, the peak level of the correlation value declines and the peak-timing detection precision in comparison with 4×oversampling or 8×oversampling.

Thus, with 2×oversampling according to the prior art, a problem which arises is that path detection precision is poor and the line quality of the terminal is degraded by a shift in the times of the despreading codes of the main-signal demodulators. FIG. 17 is a diagram showing the relationship between receive-line quality (C/N ratio) based upon a timing shift of despreading codes in the main-signal demodulators and error rate BER (Bit Error Rate) of the symbol signal, in which A represents an ideal BER•CN ratio characteristic in the case of 4×oversampling, B an actual BER•CN ratio characteristic in the case of 4×oversampling, and C a BER•CN ratio characteristic in the case of 2×oversampling. With 2×oversampling, the characteristic deteriorates by about 1.2 dB in comparison with 4×oversampling. In other words, the larger the number of oversamplings, the smaller the BER for the same C/N ratio.

Second Problem

The timing decision unit 7e (FIG. 12) detects peak timing that is above a threshold value and greater than a fixed interval and decides despread-start timing in the fingers of each of the paths based upon the results of detection. FIG. 18 shows an example in which the threshold value is P and the peak-timing interval is one chip period. The peak level is greater than the threshold value at Timing-A, Timing-B and Timing-C, and the peak-timing interval is equal to or greater than one chip period. Accordingly, Timing-A, Timing-B and Timing-C are the delay times of each path of multipath and represent the despread-start timings of the fingers corresponding to these paths.

In reflective interference caused by various conditions specific to a mobile station in the course of arrival of a signal, which has been transmitted from the mobile station, at the antenna of a base station, there are cases where a direct wave (a wave that arrives on the shortest path) and a reflected wave, or two reflected waves, arrive at the antenna of the base station at a delay of less than one chip period. In such cases the result of correlation in the searcher of the base station is obtained by combining the two waves, and the peak position detected based upon the result of correlation differs from the original peak positions of the two waves. This gives rise to an error in detected position. FIG. 19 is a diagram useful in describing this condition. In the prior art, Timing-A and Timing-C are detected as the peak timings. However, the shape of the peak in the first half is the result of combining the correlation values of the two waves indicated by the dashed lines and, hence, Timing-A, which differs from the original peak timings T_{A}, T_{B}, is detected. If this condition occurs along the propagation path for an extended period of time, or if it occurs frequently, the quality of communication at the terminal will decline.

### SUMMARY OF THE INVENTION

Accordingly, an object the present invention is to so arrange it that path detection precision can be improved even with low-speed 2×oversampling, thereby making it possible to maintain line quality equivalent to that when 4×oversampling is performed.

Another object the present invention is to so arrange it that even if the delay time difference between two waves (a direct wave and reflected wave or two reflected waves) is small and these waves arrive at a CDMA receiving apparatus close together, the arrival time of each wave, namely the delay times of respective ones of the paths, can be detected correctly, thereby making it possible to maintain line quality.

According to the present invention, the foregoing objects are attained by providing a CDMA receiving apparatus for receiving a signal that is the result of spreading transmit data by a spreading code sequence of a predetermined chip frequency, and demodulating the transmit data by applying despread processing to the receive signal using a code sequence identical with the spreading code sequence. The CDMA receiving apparatus has an AD conversion unit for converting the receive signal to digital data and outputting digital data of a prescribed sampling speed; a correlation calculation unit for calculating correlation between a reference code sequence, which is a code sequence identical with the spreading code sequence, and the digital data sequence; an interpolator for performing interpolation between correlation values to thereby generate a correlation-value data sequence having a frequency that is N (e.g., four) times the chip frequency; and a timing decision unit, to which interpolated correlation values are input, for obtaining a timing, at which a peak value of the correlation values exceeds a set value, as a delay time of a signal that arrives via a prescribed path, and deciding despread-start timing based upon this delay time.

For example, an AD converter in the AD conversion unit subjects the receive signal to an AD conversion by oversampling the receive signal at a sampling speed that is N times the chip frequency, a data downsampler downsamples the data sequence, which is output from the AD converter, to make 1/M (M<N) the number of items of data, and outputs digital data the sampling speed of which is N/M times the chip frequency, and the interpolator performs interpolation between the correlation values to generate the correlation-value data sequence having a frequency that is N times the chip frequency.

Alternatively, the AD conversion unit subjects the receive signal to an AD conversion by oversampling the receive signal at a sampling speed that is N/M (M<N) times the chip frequency, and outputs the converted signal, and the interpolator performs interpolation between the correlation values to generate the correlation-value data sequence having a frequency that is N times the chip frequency.

If the above arrangement is adopted, the speed of transmission from the side of the AD converter to the side of the main-signal demodulator can be reduced from the speed of Nx oversampling to the speed of N/M·x low-speed oversampling. Moreover, line quality equivalent to that when Nx oversampling is performed can be maintained by performing interpolation.

Further, the interpolator is constructed by a delay memory for storing correlation values, which are output from the correlation calculation unit, while shifting the values successively by a clock having a frequency that is N times the chip frequency; an interpolated-value calculation unit for adding pairs of correlation values in which the values in each pair are at storage locations of the delay memory situated at positions symmetrical with respect to the center of the delay memory, multiplying each sum obtained from this addition by a predetermined coefficient, and adding the products obtained from this multiplication to thereby calculate an interpolated value; and a selector for selectively outputting a correlation value output from the correlation calculation unit and interpolated value output from the interpolated-value calculation unit. In accordance with such an interpolator, it is possible to obtain a receive-signal impulse response that is equivalent to a receive-signal impulse response of 4×oversampling, as a result of which line quality can be maintained.

Further, the timing decision unit of the CDMA receiving apparatus decides the delay times (the despread-start timings) of two paths based upon correlation-value peak timing when it is detected, from an interpolated correlation value (which corresponds to a correlation value based upon Nx oversampling), that the despread-start timings of two paths are in close proximity to each other. As a result, even if two waves arrive at the CDMA receiving apparatus close together, the arrival time of each wave, namely the correlation-value peak timings of respective ones of the waves, can be detected correctly, thereby making it possible to maintain line quality.

Other features and advantages of the present invention will be apparent from the following description taken in conjunction with the accompanying drawings.

### BRIEF DESCRIPTION OF THE DRAWINGS

FIG. 1 is a block diagram of a CDMA receiving apparatus according to a first embodiment of the present invention;

FIG. 2 is a diagram showing an embodiment of an interpolator;

FIGS. 3A, 3B and 3C are diagrams useful in describing receive-signal impulse response in various states;

FIGS. 4A and 4B are diagrams useful in describing receive-signal impulse response in a case where interpolation is not performed;

FIG. 5 is a block diagram of a CDMA receiving apparatus according to a first modification;

FIG. 6 is a block diagram of a CDMA receiving apparatus according to a second modification;

FIG. 7 is a graph showing an example of results of correlation detection in a case where two waves have been combined;

FIG. 8 is a block diagram of a CDMA receiving apparatus according to a second embodiment of the present invention;

FIG. 9 is a diagram useful in describing processing for detecting close approach of path delay times and processing for deciding delay times (despread-start timings) of respective ones of the paths;

FIG. 10 is a flowchart of processing for detecting close approach of path delay times and processing for deciding delay times (despread-start timings) of respective ones of the paths;

FIG. 11 is a block diagram of a CDMA receiver;

FIG. 12 is a block diagram illustrating one channel of a CDMA receiving section in the CDMA receiver of a base station according to the prior art;

FIG. 13 is a block diagram of a matched filter according to the prior art;

FIG. 14 is a diagram useful in describing path search performed by a searcher according to the prior art;

FIG. 15 is a diagram for describing the cell structure surrounding a base station according to the prior art;

FIG. 16 is a block diagram showing the entirety of a CDMA receiving apparatus according to the prior art;

FIG. 17 is a diagram showing the relationship between receive-line quality (C/N ratio) based upon a timing shift of despreading codes in main-signal demodulators and error rate BER of a symbol signal;

FIG. 18 is a diagram useful in describing detection of delay time of each of multiple paths; and

FIG. 19 is a diagram useful in describing the problems of the prior art in a case where path delay times approach each other.

### DESCRIPTION OF THE PREFERRED EMBODIMENTS

(A) First Embodiment

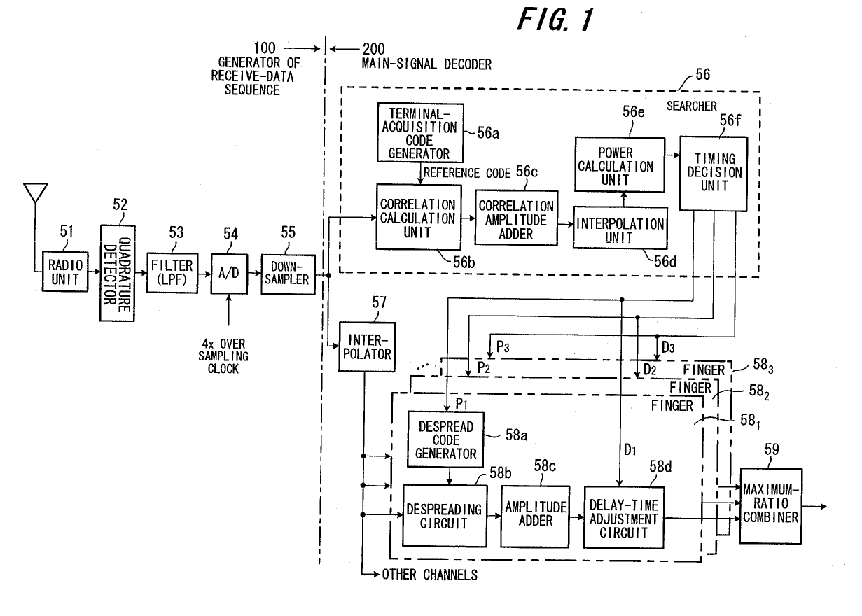

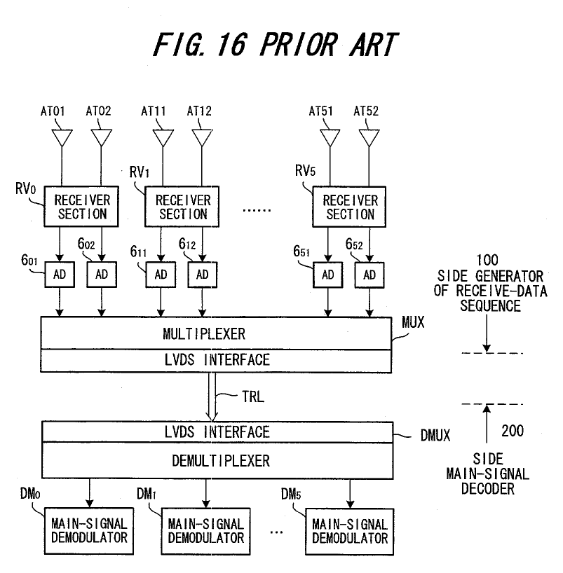

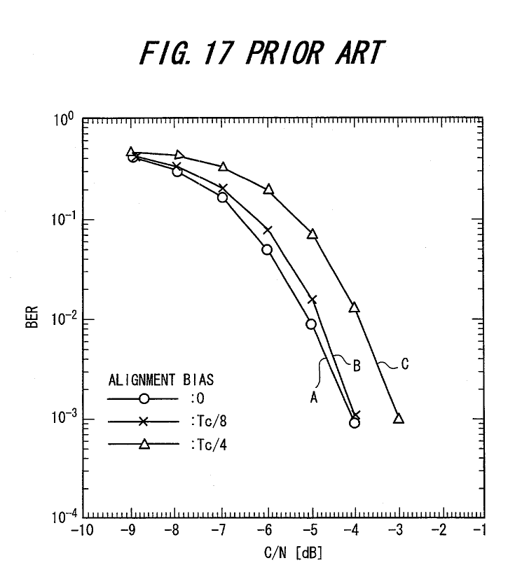

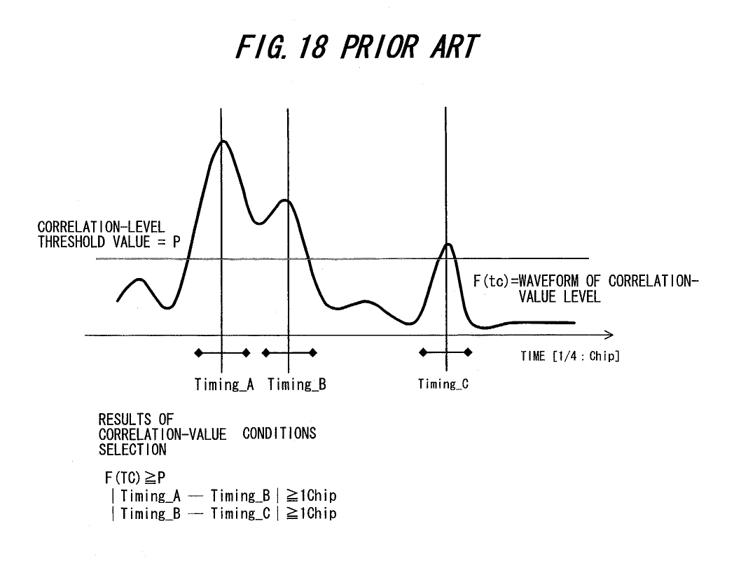

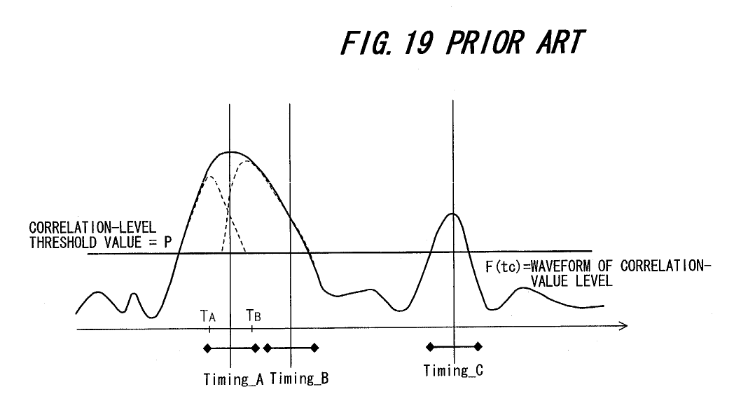

FIG. 1 is a block diagram of a CDMA receiving apparatus according to a first embodiment of the present invention. A side 100 on which a receive data sequence is generated and a side 200 on which the main signal is decoded are connected by the multiplexer MUX, transmission line TRL and demultiplexer DMUX, as shown in FIG. 16, although these are not illustrated in FIG. 1. Further, though components for only one channel are shown on the side 200 of the demodulator, identical components are provided for each channel.

A radio unit 51 converts a high-frequency signal, which has been received by an antenna, to a baseband signal by a frequency conversion (RF→IF conversion). A quadrature detector 52 subjects the baseband signal to quadrature detection and outputs in-phase component (Ich component) data and quadrature component (Qch component) data. A low-pass filter (LPF) 53 limits the band of the output signal and an AD converter 54 outputs digital data sequences by oversampling the Ich-component signal and Qch-component signal at a sampling speed that is four times the chip frequency. A downsampler 55 downsamples every other item of data in the digital data sequence, thereby substantially obtaining a 2×oversampled data sequence, and inputs this data sequence to a searcher 56 and also to each of fingers 58₁ to 58₃ via an interpolator 57.

The searcher 56 has a terminal-acquisition code generator 56a for generating a spreading code, which conforms to the channel assigned to the user terminal, as a terminal acquisition code (reference code); a correlation calculation unit 56b for performing a correlation operation between a receive data sequence output from the AD converter 54 and the reference code sequence at a speed that is twice the chip frequency; a correlation amplitude adder 56c for adding the results (amplitudes) of the correlation operation and outputting a correlation value of a predetermined timing; an interpolation unit 56d for performing an interpolation between the correlation values to generate a correlation-value data sequence the frequency whereof is four times the chip frequency; a power calculation unit 56e for calculating the absolute value or power of the correlation value; and a timing decision unit 56f for deciding despread-start timing (phase) of each path.

Let In (n=1, 2, . . . ) represent the reference code sequence of the Ich component, a(tn) (n=1, 2, . . . ) the digital data sequence of the Ich component output from the downsampler 55, Qn (n=1, 2, . . . ) the reference code sequence of the Qch component, and b(tn) (n=1, 2, . . .) the digital data sequence of the Qch component output from the downsampler 55. The correlation calculation unit 56b and correlation amplitude adder 56c perform the following operation at a speed that is twice the chip frequency:

Σₙ{a(tn)·In+jb(tn)·Qn}(n=1, 2, . . . )

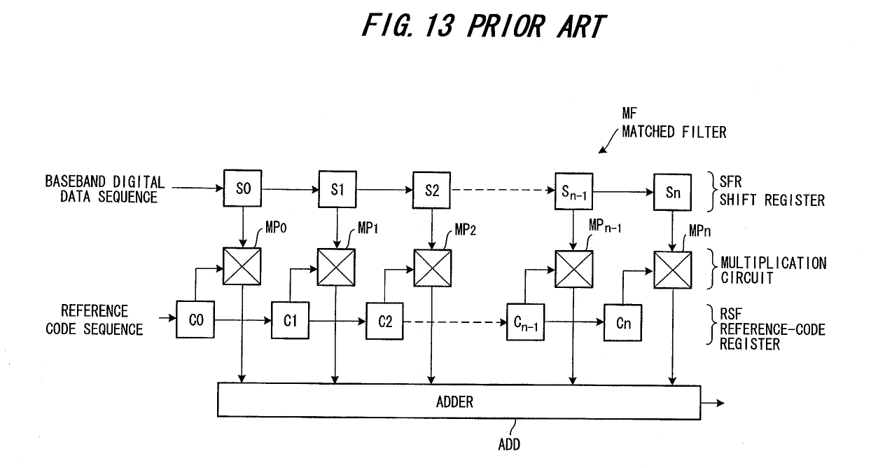

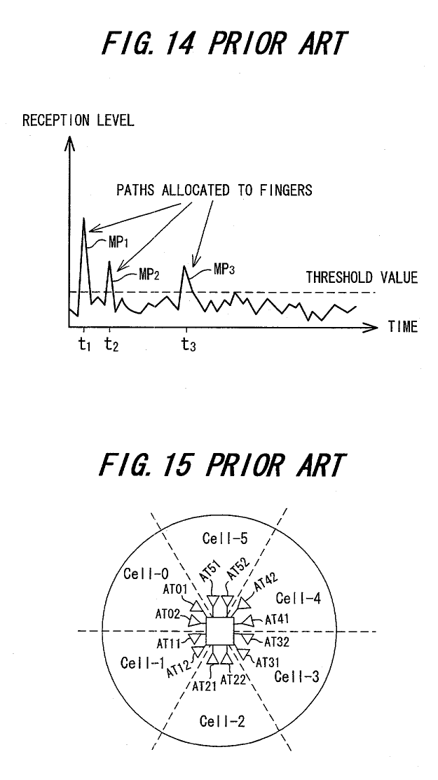

That is, the correlation amplitude adder 56c outputs correlation values at a speed that is twice the chip frequency. The correlation calculation unit 56b and correlation amplitude adder 56c can be constructed by the matched filter MF shown in FIG. 13 or by a sliding correlator.

The interpolation unit 56d performs an interpolation operation between correlation values input thereto at a speed that is twice the chip frequency, thereby generating a correlation-value data sequence whose frequency is four times the chip frequency. The power calculation unit 56e calculates the power of the correlation value at the chip period in accordance with the following formula at a speed that is four times the chip frequency:

Σₙ{[a(tn)·In]²+[b(tn)·Qn]²}(n=1, 2, . . . )

When the correlation signal is input to the timing decision unit 56f from the power calculation unit, the timing decision unit 56f detects the timing (peak timing) at which the peak exceeds a threshold value, i.e., the delay time of each path of the multiple paths. Next, the timing decision unit 56f inputs despread-start timing signals P₁, P₂, P₃ and delay-time adjustment data D₁, D₂, D₃ to respective ones of the fingers 58₁ to 58₃ corresponding to the respective paths. Since correlation values equivalent to those for the case of 4×oversampling are input to the timing decision unit 56f owing to interpolation, peak timing can be detected at a precision that is four times that for the case where no oversampling is carried out.

The interpolator 57 performs interpolation between items of data of the 2×oversampled digital data output from the downsampler 55, thereby reconstructing the 4×oversampled data sequence and inputting the latter to each of the fingers 58₁ to 58₃.

The fingers 58₁ to 58₃ corresponding to the respective paths are identically constructed and include a despreading code generator 58a for generating a receive-signal demodulation despreading code; a despreading circuit 58b for multiplying the 4×oversampled digital data sequence, which is output from the interpolator 57, by the despreading code to thereby despread the data; an amplitude adder 58c for adding the results (amplitudes) of despreading; and a delay-time adjustment circuit 58d for subjecting the despread signal to a delay-time adjustment corresponding to the path. The despreading circuit 58b applies despread processing to the digital data sequences (I-channel data sequence and Q-channel data sequence) using the despreading codes of its own channel at the timings P₁ to P₃ specified by the searcher 56 and at a speed that is four times the chip frequency. The amplitude adder 58c adds the results (amplitudes) of despreading, and the delay-time adjustment circuit 58d outputs the result of despreading upon applying the delays D₁ to D₃ specified by the searcher 56. As a result, the fingers 58₁ to 58₃ perform despreading at a timing identical with that of the spreading code on the transmitting side, adjust delay time in accordance with the paths and input the resulting signals to a maximum-ratio combiner 59 upon matching the phases. The maximum-ratio combiner 59 executes RAKE combining and inputs the combined signals to a data decoder, which is not shown.

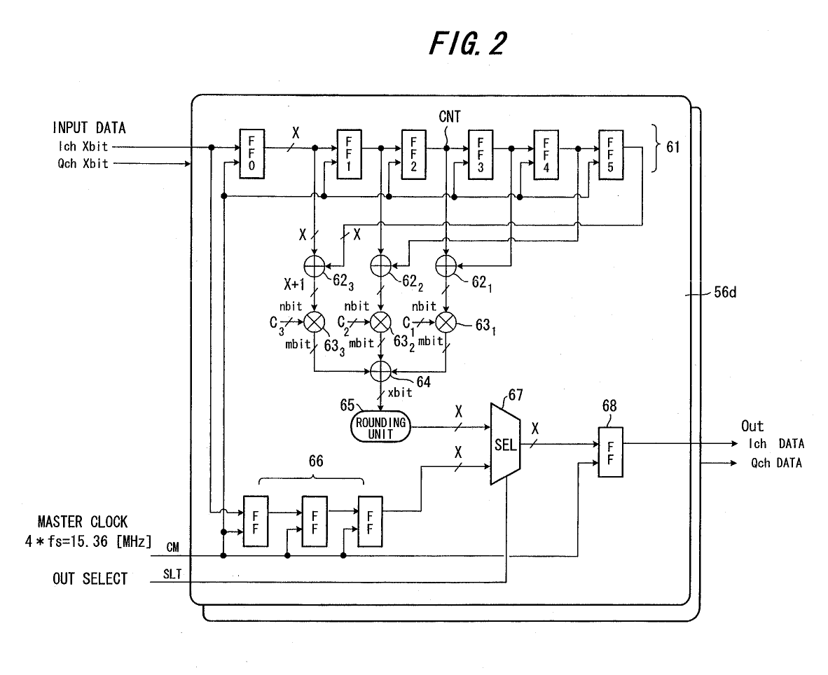

FIG. 2 shows an embodiment of the interpolation unit 56d. Since a peak value that exists between two points must also be interpolated, the interpolation unit 56d cannot employ a simple interpolator that performs interpolation based upon an average value between the two points.

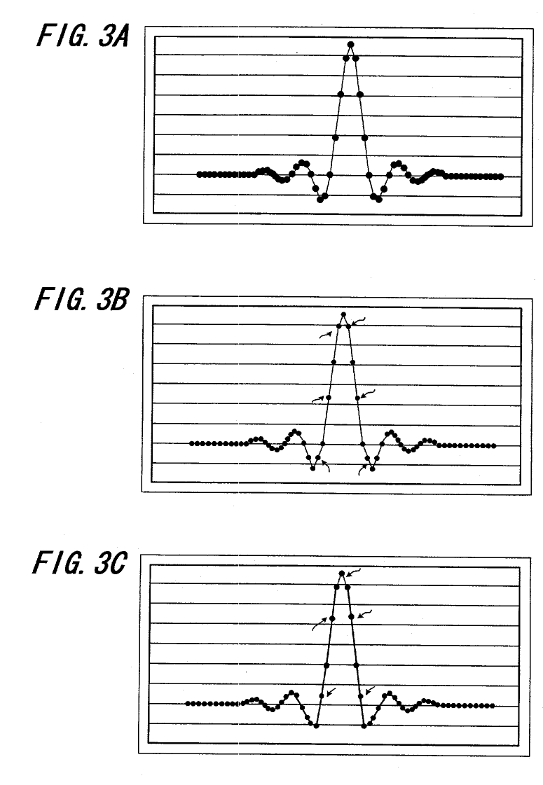

Owing to the characteristic of the band limiting filter 53, the receive-signal impulse response at the time of 4×oversampling has the waveform shown in FIG. 3A. Accordingly, it is necessary to decide coefficients of the interpolation unit 57 in such a manner that the receive-signal impulse response when the interpolation unit 57 is provided will be a receive-signal impulse response equivalent to that shown in FIG. 3A. It should be noted that the interpolation unit 56d is provided for each of the I and Q channels, and that these interpolation units are identically constructed. In FIG. 2, only the interpolation unit of the I channel is illustrated.

The Ich correlation value output from the correlation amplitude adder 56c and corresponding to 2×oversampling is read at a master clock CM that is four times the chip frequency fs and this value is input to a 6-stage delay memory 61, whereby the content of the delay memory 61 is shifted to the right successively by the master clock. Accordingly, the same correlation values are stored in the delay memory 61 two at a time in successive fashion. Adders 62₁, 62₂ and 62₃ add correlation values that have been stored at two storage units FF2, FF3; FF1, FF4; and FF0, FF5; respectively, which are situated at positions symmetrical with respect to the center CNT of the delay memory 61. Multipliers 63₁, 63₂ and 63₃ multiply the sums from respective ones of the adders 62₁, 62₂ and 62₃ by coefficients C₁, C₂ and C₃, respectively. An adder 64 adds the products obtained from the multipliers 63₁ to 63₃ and outputs the sum to a rounding unit 65. The rounded sum is output as the interpolated value. The above-described implementation has a structure similar to that of a FIR-type low-pass filter. It should be noted that the number of stages in the delay memory 61 is shown as being six for the sake of explanation; the memory is not limited to six stages.

In parallel with the above operation, the Ich correlation value output from the correlation amplitude adder 56c is input also to a 3-stage delay memory 66, whereby the content of the delay memory 66 is shifted to the right successively by the master clock. Accordingly, the same correlation values are stored in the delay memory 66 two at a time in successive fashion, and the final stage outputs correlation values at a speed equivalent to a frequency 2×fs that is twice the chip frequency. Whenever a select-enable signal SLT having a frequency 4×fs is generated, a selector 67 alternately selects and outputs the interpolated value that is output from the adder 64 and the correlation value that is output from the delay memory 66. A register 68 stores the output of the selector 67 at the frequency 4×fs, which is four times the chip frequency. As a result, the register 68 outputs a correlation value that corresponds to 4×oversampling.

If we let the coefficients C₁, C₂, C₃ of the interpolation unit 56d be as follows:

C₁=0.605, C₂=−0.130, C₃=0.028

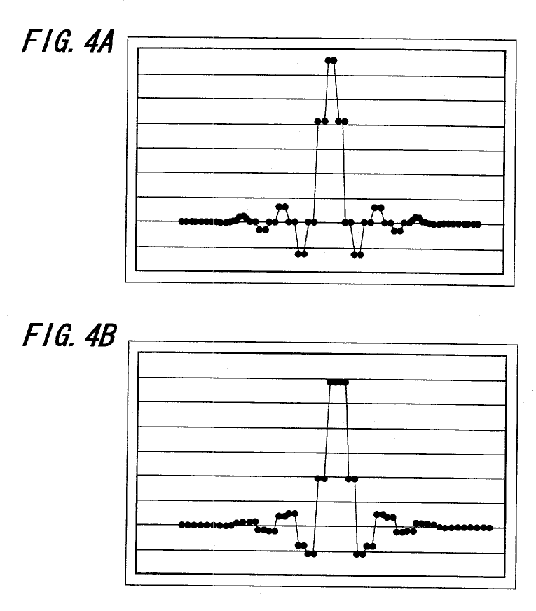

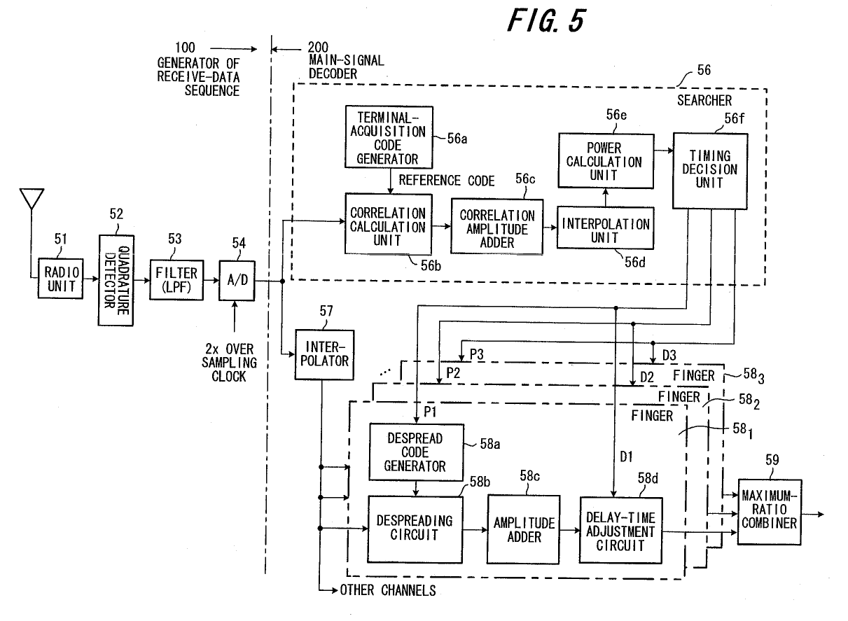

then the receive-signal impulse response when the interpolation unit is provided will be as shown in FIGS. 3B and 3C. Thus, a receive-signal impulse response identical with that shown in FIG. 3A can be obtained. It should be noted that FIGS. 3A and 3B are examples obtained by interpolating values indicated by the arrows. These examples resemble very closely the impulse response shown in FIG. 3A. For the sake of comparison, FIGS. 4A and 4B illustrate receive-signal impulse response in a case where interpolation is not performed.

Thus, the interpolation unit 56d is capable of generating a correlation-value data sequence equivalent to that obtained by 4×oversampling. As a result, it is possible to decide peak timing, i.e., path delay time (despread-start timing), at a precision equivalent to that of 4×oversampling. Further, by similarly constructing the interpolator 57, the interpolator 57 can generate a digital data sequence equivalent to that obtained by 4×oversampling. In accordance with the present invention, therefore, the speed of transmission from the generator 100 of the receive data sequence to the main-signal demodulator 200 can be reduced by half. Moreover, it is possible to maintain a line quality equivalent to that obtained by 4×oversampling.

Generally speaking, therefore, the first embodiment is such that the AD converter 54 converts the receive signal to digital data by oversampling at a sampling speed that is N times the chip frequency. The downsampler 55 downsamples the data sequence, which is output from the AD converter 54, to make 1/M (M<N) the number of items of data, and outputs digital data the sampling speed of which is N/M times the chip frequency. The interpolation unit 56d performs interpolation between the correlation values to generate a correlation-value data sequence having a frequency that is N times the chip frequency. As a result, according to the first embodiment, the speed of transmission from the side of the AD converter to the side of main-signal demodulator can be reduced from the speed of N (=4)×oversampling to the speed of a N/M (4/2=2)×low-speed oversampling. Moreover, line quality equivalent to that when N (=4)×oversampling is performed can be maintained by interpolation.

(B) Modification

(a) First Modification

In the first embodiment of FIG. 1, the downsampler 55 downsamples data from the digital data sequence obtained by 4×oversampling in the AD converter 54, whereby a digital data sequence equivalent to that obtained with 2×oversampling is generated. This digital data sequence is sent to the side of the main-signal demodulator 200. It is possible, however, to delete the downsampler 55.

FIG. 5 illustrates a modification for a case where the downsampler 55 is deleted. Components identical with those shown in FIG. 1 are designated by like reference characters. The modification differs in that \mathring{1} the downsampler is deleted; \mathring{2} 2×oversampling is performed by the AD converter 54; and \mathring{3} the digital data sequence obtained by 2×oversampling is input to the searcher 56 directly and is input also to the fingers 58a to 58e via the interpolator 57. This modification provides actions and effects similar to those of the first embodiment.

Generally speaking, therefore, this modification is such that the AD converter 54 converts the analog receive signal to digital data by oversampling at a sampling speed that is N/M (M<N) times the chip frequency, and the interpolation unit 56d performs interpolation between the correlation values to generate a correlation-value data sequence of a frequency that is N times the chip frequency. In FIG. 5, N=4, M=2 holds.

(b) Second Modification

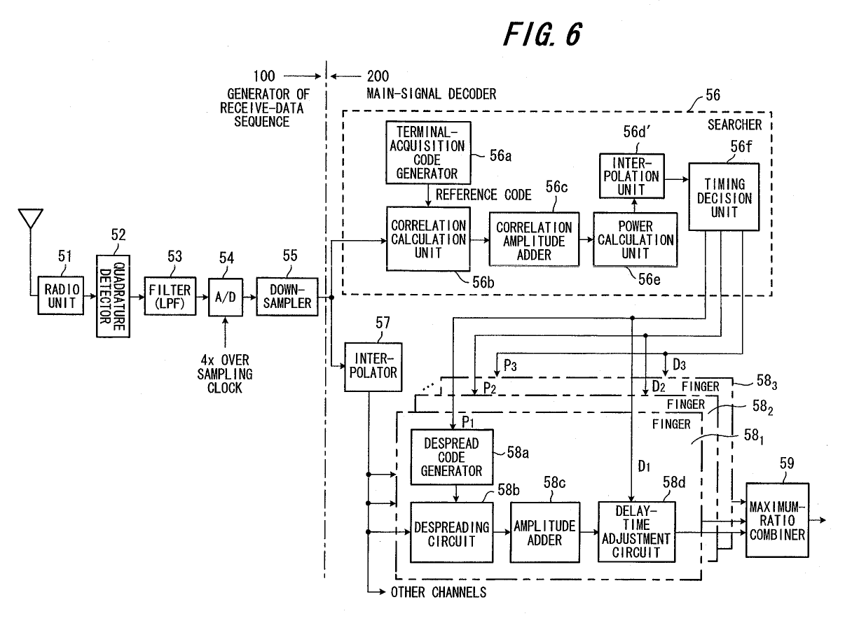

In the first embodiment of FIG. 1, interpolation is performed between correlation values output from the correlation amplitude adder 56c. However, it is also possible to perform interpolation between values of correlation power output from the power calculation unit 56e. FIG. 6 shows a modification in which interpolation is performed between values of correlation power. Here components identical with those shown in FIG. 1 are designated by like reference characters. This modification differs from the first embodiment in that an interpolation unit 56d′ is provided on the output side of the power calculation unit 56e and performs interpolation between values of interpolation power.

In this modification, the input value to the interpolation unit 56d′ is an absolute value or power and therefore a negative (minus) value does not exist. Accordingly, impulse response following interpolation processing becomes a value obtained by flipping, to the positive (plus) side, a negative value of impulse response obtained in the first embodiment. If the actual operating level is taken into account, the level is very low in comparison with the level of the maximum value even though the negative value is flipped over to the positive side. As a result, the level becomes buried in the levels of other non-correlation values and the possibility that it will not appear is very high. No problems, therefore, arise.

(C) Second Embodiment

In the prior art, the timing decision unit in the searcher is such that when a correlation result above a fixed threshold value is acquired, the decision unit selects a peak timing for which the level is high as the delay time of a path in multipath. Next, as the delay time of another path of multipath, the timing decision unit selects a timing, the peak level of which is above the fixed threshold value, at a point more than one chip period farther along the time axis. The delay times of each of the paths are thus selected. On the basis of these selected delay times, the timing decision unit decides the despread-start timing in the main-signal demodulator corresponding to each path.

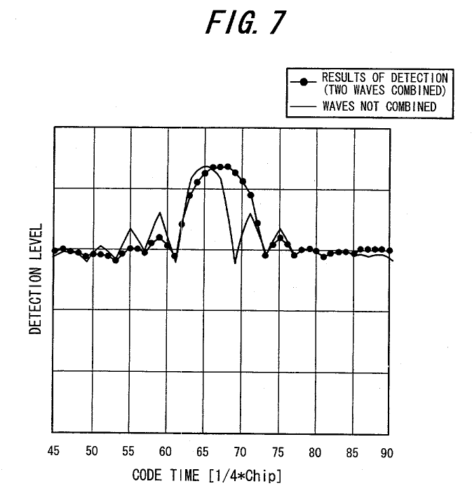

With the prior-art method mentioned above, no problems arise so long as there is a difference of one chip period or greater between the delay times of respective paths. However, if the difference between delay times is less than one chip period, two paths will be regarded as one path. In addition, the peak timing of the combined correlation value will differ from the ideal timings of the individual paths. Even if 4×oversampling is performed in such case, the result will be similar to that obtained with 2×oversampling in the worst case, and an alignment bias shift of Tc/4 will occur, as indicated in FIG. 7 showing a case in which two waves are combined. This degrades the demodulated signal.

Accordingly, in the present invention, it is so arranged that the correct delay times of two paths are decided based upon the peak timings of correlation values.

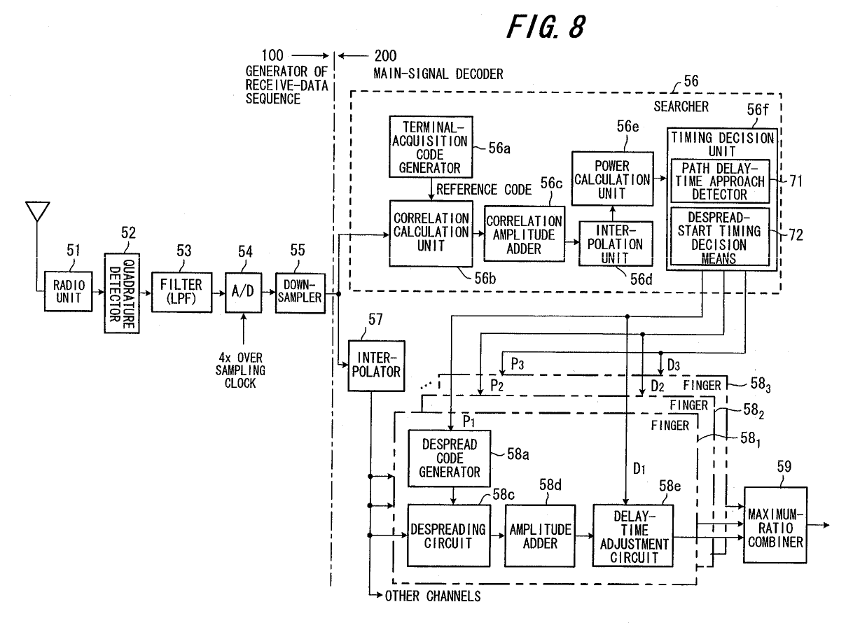

FIG. 8 is a block diagram illustrating the second embodiment of the present invention, in which components identical with those of the first embodiment are designated by like reference characters. This embodiment differs in that \mathring{1} the structure of the timing decision unit 56f is clarified and \mathring{2} in the timing decision processing executed by the timing decision unit 56f.

The timing decision unit 56f includes a path delay-time approach detector 71 for detecting that the difference between delay times of two paths is small, namely that the despread-start timings are in close proximity to each other, and despread-start timing decision means 72 for obtaining the delay time of each path and deciding the despread-start timings of the fingers corresponding to these paths based upon the delay times.

More specifically, the path delay-time approach detector 71 subdivides the time axis at units of the period (=1/4·chip period) of 4×oversampling, compares the level within a range of one chip period before and after a peak timing at which the correlation level is maximized with the maximum level, and judges that a plurality of waves have been combined if the difference between these levels is less than a threshold value. Further, if a plurality of waves have been combined, the despread-start timing decision means 72 compares the levels within the range of each of the two chips centered on the maximum level value and specifies the delay time (despread-start timing) of each of the combined paths based upon the difference between the compared levels.

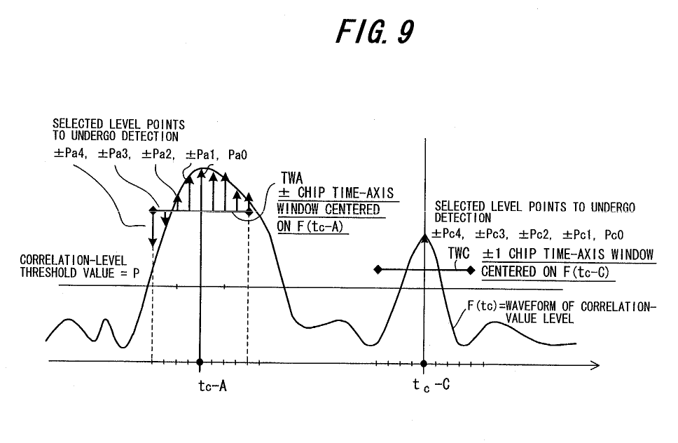

FIG. 9 is a diagram useful in describing processing for detecting close approach of path delay times and processing for deciding delay times (despread-start timings) of respective ones of the paths.

In the present invention, timings tc-A, tc-C are detected in a manner similar to that of the prior-art example from correlation values F(tc) of a high level above a correlation-level threshold value P. Next, time-axis windows TWA, TWC of one chip duration before and after the maximum level are set. This is followed by comparing correlation level Pa0 with correlation levels ±Pa1, ±Pa2, ±Pa3, ±Pa4 (correlation level Pc0 with correlation levels ±Pc1, ±Pc2, ±Pc3, ±Pc4) within the windows in units of one-quarter of a chip, detecting whether the delay times of two paths, namely the despread-start timings of two paths, are in close proximity to each other, and deciding the delay times (despread-start timings) of the two paths correctly based upon the peak timing of the correlation value.

The criteria Eor judging whether the delay times of two paths are close together are as follows:

1. Whether correlation values within the range of a time-axis window centered on the timing of the maximum level are symmetrical with respect to this center is investigated. If the correlation values are symmetrical and the difference between the maximum level of a correlation value and a correlation value within the range of the time-axis window is equal to or greater than a set level, it is judged that the delay times of the paths are not close together. This utilizes the fact that the level. difference with respect to the maximum level (at the center of the window) within a certain time-axis window approximates the impulse response (roll-off impulse response) of a send/receive band limiting filter.

2. If the difference between the peak value of correlation values and a correlation value within the range of the time-axis window is less than a set level, then, even if the correlation values within the range of the time-axis window centered on the maximum-level timing are symmetrical with respect to this center, it is judged that the delay times of the two paths are close together.

3. If the correlation values within the range of a time-axis window centered on the timing of the maximum level are not symmetrical with respect to this center, it is judged that the delay times of the two paths are close together.

Criteria for deciding the delay times of two paths that are close together are as follows:

1. Even if correlation values within a prescribed range centered on the peak timing are symmetrical with respect to this center, prescribed timings having left-right symmetry centered on the peak timing are adopted as the delay times of the respective paths if it is judged that the delay times of the two paths are close together.

2. If correlation values within a prescribed range centered on the peak timing are not symmetrical with respect to this center and the shape of the peak is such that the peak diminishes more gently on a first side than on a second side with the peak timing serving as the center, then the delay times of the two paths are decided in such a manner that the length of time between the peak timing and a timing that specifies the delay time on the first side will be smaller than the length of time between the peak timing and a timing that specifies the delay time on the second side.

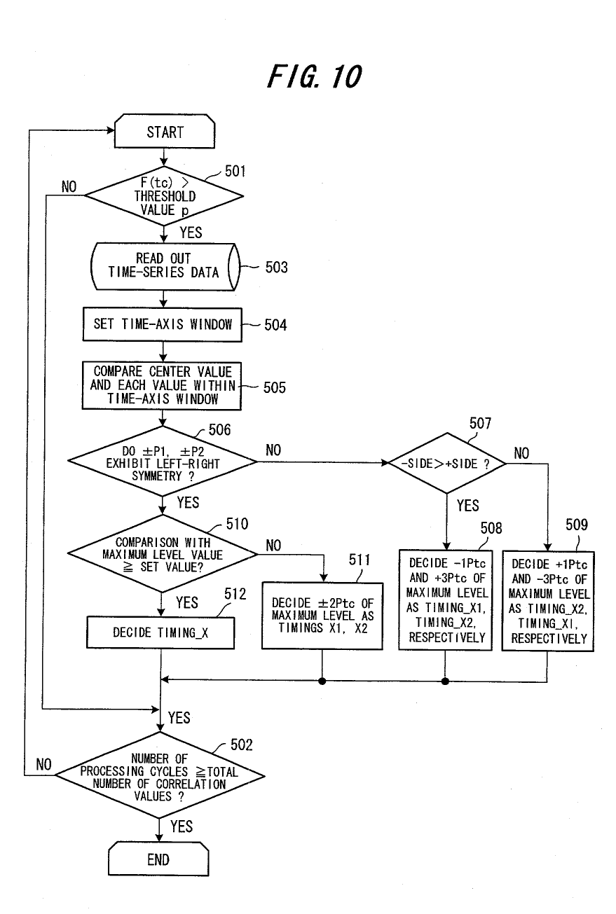

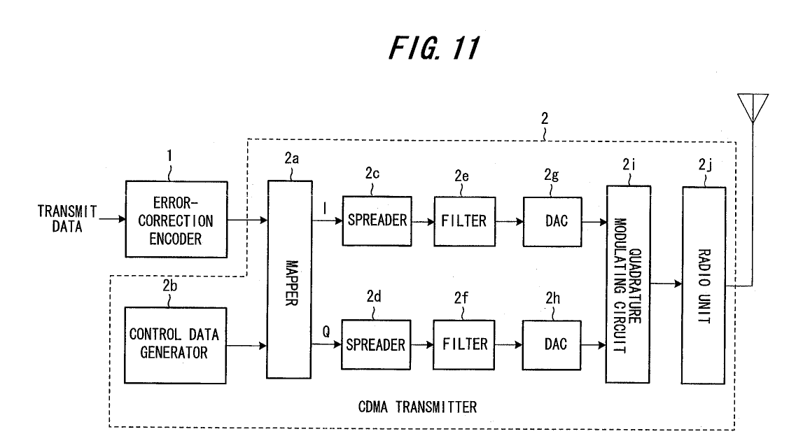

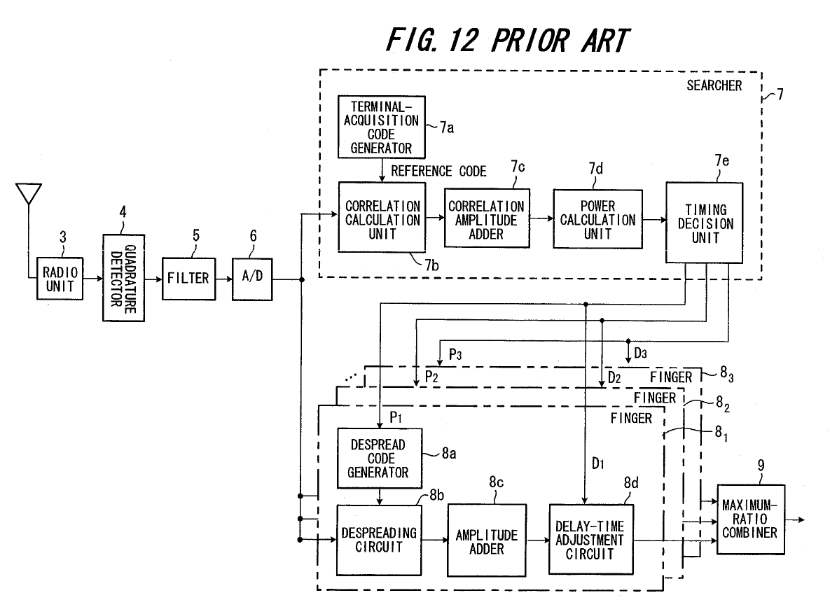

FIG. 10 is a flowchart of processing for detecting close approach of path delay times and processing for deciding delay times (despread-start timings) of respective ones of the paths in the timing decision unit 56f.

Correlation values F(tc) of 4×oversampling obtained by interpolation are read out of a memory (not shown) successively and it is determined whether the correlation values F(tc) are greater than a threshold value P (step 501). If the correlation value is not greater than the threshold value (“NO” at step 501) then it is determined whether processing is finished with regard to all correlation values (step 502). If the answer is “NO” at step 502, the next correlation value F(tc) is read out and similar processing is repeated.

If it is found at step 501 that the correlation value F(tc) is greater than the threshold value P, then correlation values in the vicinity of timing tc that give this correlation value F(tc) are read out of the memory (step 503), the peak timing that gives the peak level is obtained and a width of one chip before and one chip after this peak timing is set as the time-axis window (step 504). Next, the center level (peak level) Pa0 within the time-axis window is compared with the correlation levels ±Pa1, ±Pa2, ±Pa3, ±Pa4 (see FIG. 9) (step 505).

With regard to each of the sets ±Pa1, ±Pa2, ±Pa3, ±Pa4, it is determined whether the values are equal and it is then determined, based upon the result, whether the shape of the peak has left-right symmetry about the peak level Pa0 as center (step 506). If the shape of the peak does not have left-right symmetry (“NO” at step 506), it is judged that the delay times of the two paths have approached each other to within less than the width of one chip.

Next, with regard to each of the sets ±Pa1, ±Pa2, ±Pa3, ±Pa4, the magnitudes of the values are investigated and then it is determined, based upon the result of investigation, which side, i.e., the left side (the negative side) or the right side (the positive side), about the peak level Pa0 as center, diminishes gently (step 507). If the left side is the gently diminishing side (−Pai>+Pai), then the position onequarter of a chip to the left of the peak timing is adopted as delay time (Timing-X1) of the first path and the position three-quarters of a chip to the right of the peak timing is adopted as delay time (Timing-X2) of the second path (step 508). On the other hand, if the right side is the gently diminishing side (−Pai<+Pai), then the position one-quarter of a chip to the right of the peak timing is adopted as delay time (Timing-X2) of the second path and. the position three-quarters of a chip to the left of the peak timing is adopted as delay time (Timing-X1) of the first path (step 509).

If it is found at step 506 that the shape of the peak has left-right symmetry about the peak level Pa0 as center, then the difference between the peak level Pa0 and each of the correlation levels ±Pa1, ±Pa2, ±Pa3, ±Pa4 is calculated and it is determined whether all of these differences are less than a set value (step 510). If all of the differences are less than the set value, then it is judged that the delay times of the two paths have approached each other to within less than the width of one chip. Positions 2/4 of a chip to the left and 2/4 of a chip to the right of the peak level are adopted as the delay times (Timing-X1, Timing-X2) of the first and second paths (step 511).

If it is found at step 510 that even one of the differences between the peak level Pa0 and correlation levels ±Pa1, ±Pa2, ±Pa3, ±Pa4 is equal to or greater than the set value, then it is judged that the delay times of the two paths are not close together and the peak timing is made the delay time Timing-X of the path (step 512).

It is then determined whether processing for all correlation values has been completed (step 502). If the answer is “NO”, the next correlation value is read out and processing is repeated from step 501 onward.

Thus, in accordance with the second embodiment, when it is detected that the delay times (despread-start timings) of two paths are close together, the delay times of the two paths are decided based upon the correlation-value peak timing. As a result, even if two waves arrive at the receiving apparatus close together, the arrival time of each wave, i.e., the delay time of each path, is obtained correctly, the despread-start timings are decided correctly based upon these delay times and the line quality of each path can be maintained.

Thus, in accordance with the present invention, the speed of transmission from the side of an AD converter to the side of a main-signal demodulator can be reduced from the speed of Nx (=4×) oversampling to the speed of N/M·x (=2×) low-speed oversampling. Moreover, line quality equivalent to that when Nx oversampling is performed can be maintained by performing interpolation.

Further, in accordance with the present invention, by appropriately designing an interpolator, it is possible to obtain a receive-signal impulse response that is equivalent to a receive-signal impulse response of 4×oversampling, as a result of which line quality can be maintained.

Further, in accordance with the present invention, when it is detected that the delay times (despread-start timings) of two paths are close to each other, the delay times of the two paths are decided based upon the peak timing of correlation values. As a result, even if two waves arrive at the receiving apparatus close together, the arrival time of each wave, i.e., the delay time of each path, is obtained correctly, the despread-start timings are decided correctly based upon these delay times and the line quality of each path can be maintained.

As many apparently widely different embodiments of the present invention can be made without departing from the spirit and scope thereof, it is to be understood that the invention is not limited to the specific embodiments thereof except as defined in the appended claims.

What is claimed is:

1. A CDMA receiving apparatus for receiving a signal that is the result of spreading transmit data by a spreading code sequence of a predetermined chip frequency, and demodulating the transmit data by applying despread processing to the receive signal using a code sequence identical with the spreading code sequence, said apparatus comprising:
an AD conversion unit for converting the receive signal to digital data and outputting a digital data sequence of a prescribed sampling speed;
a correlation calculation unit for calculating correlation between a reference code sequence, which is a code sequence identical with the spreading code sequence, and the digital data sequence;
an interpolator for performing interpolation between correlation values to thereby generate a correlation-value data sequence having a frequency that is N times the chip frequency; and
a timing decision unit, to which interpolated correlation values are input, for obtaining a timing, at which a peak value of the correlation values exceeds a set value, as a delay time of a signal that arrives via a prescribed path, and deciding despread-start timing based upon this delay time.

2. The apparatus according to claim 1, wherein said interpolator includes:
a delay memory for storing correlation values, which are output from the correlation calculation unit, while shifting the values successively by a clock having a frequency that is N times the chip frequency;
an interpolated-value calculation unit for adding pairs of correlation values in which the values in each pair are at storage locations of said delay memory situated at positions symmetrical with respect to the center of said delay memory, multiplying each sum obtained from this addition by a predetermined coefficient, and adding the products obtained from this multiplication to thereby calculate an interpolated value; and
a selector for selectively outputting a correlation value output from said correlation calculation unit and an interpolated value output from said interpolated-value calculation unit.

3. The apparatus according to claim 2, wherein the coefficients are decided in such a manner that a receive-signal impulse equivalent to a receive-signal impulse response that prevails when Nx oversampling is performed by said AD converter and interpolation is not applied, will be obtained.

4. The apparatus according to claim 1, further comprising an arithmetic unit for calculating an absolute value or power of the correlation value, said interpolator being provided in front of or in back of said arithmetic unit;
wherein said timing decision unit adopts, as a delay time of a signal that arrives via a prescribed path, a timing at which a peak value of absolute values or powers of correlation values exceeds a set value.

5. The apparatus according to claim 1, wherein said AD conversion unit includes:
an AD converter for subjecting the receive signal to an AD conversion by oversampling the receive signal at a sampling speed that is N times the chip frequency; and
a data downsampler for downsampling the data sequence, which is output from said AD converter, to make 1/M (M<N) the number of items of data, and outputting digital data the sampling speed of which is N/M times the chip frequency.

6. The apparatus according to claim 1, wherein said AD conversion unit is an AD converter for subjecting the receive signal to an AD conversion by oversampling the receive signal at a sampling speed that is N/M (M<N) times the chip frequency, and outputting the converted signal.

7. The apparatus according to claim 5, wherein N=4, M=2 hold.

8. The apparatus according to claim 1, wherein said timing decision unit includes:
a detector for detecting that delay times of two paths are in close proximity to each other; and
a delay-time decision unit which, when the delay times of two paths are in close proximity to each other, is for deciding delay times of the two paths based upon peak timing of the correlation values.

9. The apparatus according to claim 8, wherein said detector determines whether correlation values within a predetermined range are symmetrical with respect to the peak timing as center, and judges that the delay times of two paths are in close proximity to each other if the correlation values are not symmetrical.

10. The apparatus according to claim 9, wherein if the shape of the peak is such that the peak diminishes more gently on a first side than on a second side with the peak timing serving as the center, said delay-time decision unit decides the delay time of each path in such a manner that the length of time between the peak timing and a timing that specifies the delay time on the first side will be smaller than the length of time between the peak timing and a timing that specifies the delay time on the second side.

11. The apparatus according to claim 8, wherein said detector determines whether correlation values within a predetermined range are symmetrical with respect to the peak timing as center, and judges that the delay times of two paths are in close proximity to each other, even if the correlation values are symmetrical, provided that the difference between a peak value of correlation values and a correlation value within the predetermined range is less than a set level.

12. The apparatus according to claim 11, wherein said delay-time decision unit adopts prescribed timings having left-right symmetry centered on the peak timing as the delay times of the respective paths.
